(19) United States
(12) Patent Application Publication
(10) Pub. No.: US 2004/0110485 A1
(43) Pub. Date: Jun. 10, 2004

(54) Emergency warning network

(76) Inventor: Larry G. Sweatt, Burkburnett, TX (US)

Correspondence Address: Stephen R. Greiner, Esquire, GREINER LAW OFFICES, P.C., Suite 110, 6701 Democracy Blvd., Bethesda, MD, 20817, US

(21) Appl. No.: 10/314,980

(22) Filed: Dec. 10, 2002

(51) Int. Cl. H04B 7/185

(52) U.S. Cl. 455/404.1; 455/403

(57) ABSTRACT

An emergency warning network including a base station for broadcasting warning signals at a plurality of frequencies and an earth-orbiting satellite for receiving the warning signals and rebroadcasting such to extend the range of communications of the base station. The network also includes a number of receivers for receiving the warning signals from the earth-orbiting satellite. Each of the receivers is tuned to recognize a respective one of the number of radio frequencies.

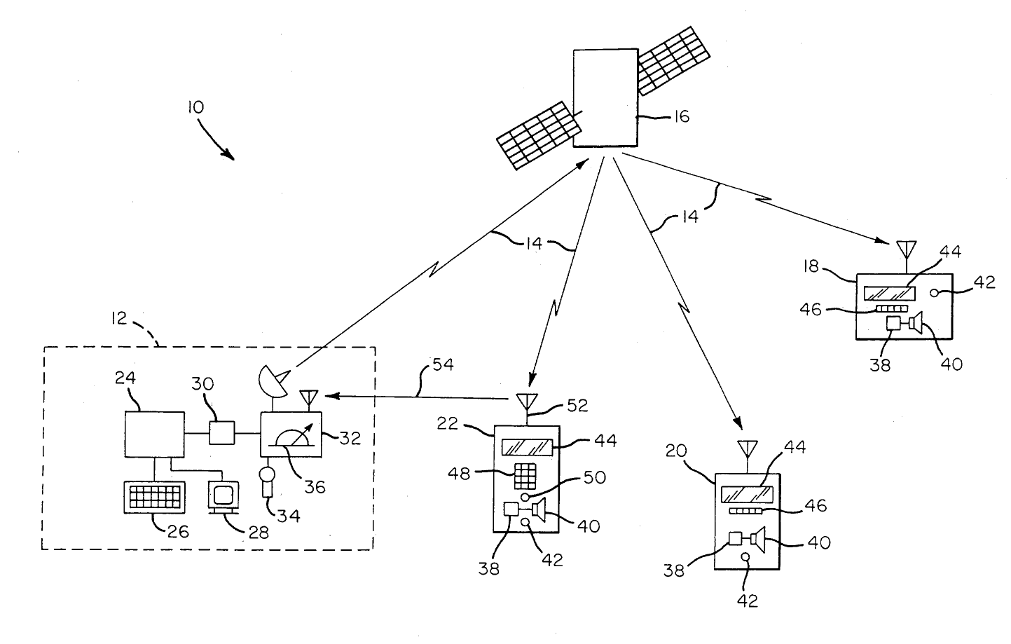

### FIELD OF THE INVENTION

The present invention relates generally to electrical communications systems and, more particularly, to such systems with particular safety functions.

### BACKGROUND OF THE INVENTION

As society has moved into the 21^{st} Century, some of its disaffected members have resorted to acts of violence and terror as a way of being heard. Some of these acts have taken the lives of thousands of people and have injured thousands more. Unfortunately, no one foresees an end to such acts. It is, of course, desirable to warn targeted groups well in advance of a terrorist act so that precautions can be taken to avoid or minimize expected harm.

To a certain extent, mass media—radio and television in particular—is effective in rapidly alerting the public of impending, ongoing, and completed acts of terrorism. One drawback of relying solely upon radio and television to provide alerts of terrorist activities is that detailed instructions from governmental leaders cannot be provided to those directly involved in providing for the health, safety and welfare of a group of people such as doctors, firemen, and policemen. The problem of communicating is compounded by our system of government where federal, state, and local responsibilities overlap. Thus, it can be difficult to provide a coordinated response to a terrorist threat, natural disaster or similar event.

### SUMMARY OF THE INVENTION

In light of the drawbacks associated with using broadcast media to rapidly and accurately disseminate information important to public health, safety and welfare, it is a principal object of the invention to provide an emergency warning network that can be used by authorized personnel to notify specified people of impending dangers. These dangers might include: terrorist alerts and advisories, fires, explosions, chemical spills, hostage takings, radiation leaks, and the spread of biological agents or poisonous gasses to name a few. Apart from news regarding dangers, real time-critical information related to weather and earth movements can be delivered to interested parties by the network.

It is a further object of the invention to provide an emergency warning network of the type described that can be employed to provide time-critical information to selected users associated with federal, state and local governmental entities. Users positioned “on the ground” are able to obtain the information wherever they may be located: at home, in the field, in a vehicle, etc.

It is another object of the invention to provide an emergency warning network of the type described that alerts users of its activation with audible and visual alarms. Once an alarm has sounded, detailed information may be obtained audibly or visually.

It is an object of the invention to provide improved elements and arrangements thereof in an emergency warning network for the purposes described whose component parts are rugged in construction, inexpensive to manufacture, easy to use, and dependable in operation.

Briefly, the emergency warning network in accordance with this invention achieves the intended objects by featuring a base station for broadcasting warning signals via an earth-orbiting satellite to a number of remote receivers. Warning signals are broadcast at different radio frequencies, each corresponding with one that a particular receiver has been tuned to recognize. Thus, the network permits information to be distributed from the base station to a particular receiver simply by varying the frequency of a warning signal broadcast.

The foregoing and other objects, features and advantages of the present invention will become readily apparent upon further review of the following detailed description of the preferred embodiment as illustrated in the accompanying drawing.

### BRIEF DESCRIPTION OF THE DRAWING

The present invention is more readily described with reference to the accompanying drawing that is a schematic diagram of an emergency warning network in accordance with the present invention.

### DETAILED DESCRIPTION OF THE PREFERRED EMBODIMENT

Referring now to the drawing, an emergency warning network in accordance with the present invention is shown at 10. Network 10 includes a base station 12 for broadcasting warning signals 14 via an earth-orbiting satellite 16 to a remote receiver such as: a desktop radio 18, a pocket pager 20 and a cellular telephone 22. Warning signals 14 are broadcast at different radio frequencies, each corresponding with one that a receiver 18, 20 or 22 has been tuned to recognize. Thus, network 10 permits information to be distributed from a single source to a selected one of a plurality of recipients simply by varying the frequency of a warning signal broadcast.

Base station 12 includes a central processing unit (CPU) 24 to which is connected a keyboard 26 for entering data into CPU 24 and a monitor 28 for scrutinizing the entered data. Data entered into CPU 24 can involve events affecting the health, safety and welfare of people inhabiting a given geographic area. CPU 24 continuously assimilates, edits and stores the input data and encodes such. The encoded data is relayed, at times selected by a network operator, by CPU 24 in the form of digital data stream to a terminal node controller (TNC) 30 where it is converted to a form that can be broadcast by radio frequency (RF) transceiver 32 to satellite 16 for relay to receiver 18, 20 or 22.

Transceiver 32 is provided with a microphone 34 so that real-time voice broadcasts can be broadcast as part of radio signal 14 and is also provided with a radio frequency selector 36 that can be adjusted by an operator to choose the frequency at which a signal 14 is broadcast. For example, a first frequency might be selected to broadcast to federal law enforcement agencies. Additional frequencies might be used to communicate with other federal, state and local entities. To further direct signals 14 to a particular receiver 18, 20 or 22, signals 14 can carry continuous, tone-coded, sub-audible squelches (CTCSS) or digital private line (DPL) codes generated by transceiver 32 to energize a particular receiver 18, 20 or 22 operating at a given frequency. CTCSS and DPL codes would be entered into CPU 24 by means of keyboard 26.

If desired, transceiver 32 can be used to gain access to established cellular telephone networks. Transceiver 32, for example, could operate under the standards established by the Global System for Mobile Communication (GSM) under which many telephone systems throughout the world operate. GSM utilizes Time Division Multiple Access (TDMA) to permit wireless communication among users. TDMA is a digital transmission technology that allows a number of users to access a single radio frequency channel without interference by allocating unique time slots to each user within a channel. A competing technology, Code-Division Multiple Access (CDMA), permits encoded transmissions over several frequencies and may also be utilized by transceiver 32 to communicate via a telephone network.

Although CPU 24 and transceiver 32 are preferably in close proximity to one another for security reasons, they may be positioned hundreds of miles apart. At a great distance, CPU 24 and transceiver 32 can be connected via the Internet. The technology employed by Internet Radio Linking Project, initiated in Canada in 1998, could be used to accomplish the Internet connection.

Each receiver 18, 20 and 22 is made to receive signals 14 at a predetermined frequency. Additionally, each receiver 18, 20 and 22 may be assigned an “address” that is accessible by means of a particular CTCSS or DPL code. The frequencies and code-accessible addresses are preferably set at the time that receivers 18, 20 and 22 are manufactured. Of course, receivers 18, 20 and 22 can be made to receive radio signals from sources other than transceiver 32 to extend their utility. Thus, receivers 18, 20 and 22 may have the capability of receiving signals 14 at different radio frequencies and at different “addresses.”

Receivers 18, 20 and 22 include features to produce a useful message from a signal 14 and to alert a user that a signal 14 has been received. In this regard, receivers 18, 20 and 22 are provided with internal decoders (not shown) that translate signals 14 which arrive in an encoded form into a form that can ultimately be understood by a user. Also, receivers 18, 20 and 22 have alarms comprising a tone generator 38 for causing a speaker 40 to emit an audible tone and an LED 42 for producing a visible light. Additionally, each receiver 18, 20 and 22 includes an LCD display 44 for reproducing any written message associated with a signal 14 that may have been typed into keyboard 26 at base station 12. Each speaker 40 is connected to a receiver 18, 20 or 22 in such a manner that it can transduce any audio input via microphone 34 that may form part of a signal 14. A reset button (not shown) on each receiver 18, 20 and 22 permits a user to deenergize the alarm, clear LCD display 44, and place the receiver 18, 20 or 22 in a “stand-by” mode waiting for the next signal 14.

Receivers 18 and 20 each include a threat level indicator 46 comprising an array of five LEDs with the colors: green, blue, yellow, orange and red to convey an impression of the immediate likelihood of an act of terror as proposed by the Office of Homeland Security. It is anticipated that each of the LEDs in the array would be represented by a unique sequence of numbers or other code that, when input into CPU 24 through keyboard 26 and broadcast by transceiver 32 would cause corresponding one of the LEDs to be illuminated.

Cellular telephone 22 has a keypad 48 and a microphone 50 for receiving inputs from a user. These inputs may comprise alphanumeric keypad entries and voice signals. The transmitter 52 of cellular telephone 22 broadcasts radio frequency signals 54 in response to the keystroke entries and voice signals. Signals 54 can be received by transceiver 32 so as to permit two-way communications between cellular telephone 22 and base station 12.

It is expected that network 10 would be used principally by governmental agencies to distribute information during crises. Base station 12, then, might be placed in the possession of an authority responsible for emergency preparedness on a national basis. Receivers 18, 20 and 22 would be placed, in the possession of entities having a regional or local presence such as military bases, state police forces, fire departments and sheriffs offices.

It is possible that base station 12 would be operated by the new Office of Homeland Security or a like entity to broadcast messages regarding events that pose a threat to the health, safety and welfare of the public. A typical message carried by a signal 14 possesses: a writing capable of visualization on a display 44 of a receiver 18, 20 or 22, a voice transmission capable of being transduced by a speaker positioned within a receiver 18, 20 or 22. CTCSS and DPL codes can also be carried by a signal 14 to direct its receipt only by a particular receiver 18, 20 or 22.

Those in possession of receivers 18, 20 and 22 can act upon the message carried by a signal 14 and, perhaps, to generate new messages with cellular telephone 22 for broadcast as a signal 54 back to transceiver 32. Thus, any threats or other dangerous events described by the operator of base station 12 are passed through network 10 in a secure and efficient manner.

While network 10 has been described with a high degree of particularity, it will be appreciated by those skilled in the art that modifications may be made thereto. Therefore, it is to be understood that network 10 is not limited to the sole embodiment described above, but encompasses any and all embodiments within the scope of the following claims.

I claim:

1. An emergency warning system, comprising:
a base station for broadcasting warning signals at a plurality of radio frequencies;
an earth-orbiting satellite for receiving said warning signals and rebroadcasting such so as to extend the range of communications of said base station; and,
a plurality of receivers for receiving said warning signals from said earth-orbiting satellite, each of said receivers being tuned to recognize a respective one of said plurality of radio frequencies.

2. An emergency warning system, comprising:
a base station including:
a CPU for assimilating, editing and storing data;
a keyboard connected to said CPU for entering data into said CPU;
a monitor connected to said CPU for scrutinizing data entered into said CPU;
an RF transceiver connected to said CPU for broadcasting, at a plurality of frequencies, said warning signals carrying data from said CPU; and,
a microphone connected to said transmitter for entraining human speech in said warning signals;
an earth-orbiting satellite for receiving said warning signals and rebroadcasting such so as to extend the range of communications of said base station; and,
a plurality of receivers for receiving said warning signals from said first, earth-orbiting satellite, each of said receivers being tuned to recognize a respective one of said plurality of radio frequencies.

3. An emergency warning system, comprising:
a base station including:
a CPU for assimilating, editing and storing data;
a keyboard connected to said CPU for entering data into said CPU;
a monitor connected to said CPU for scrutinizing data entered into said CPU;
an RF transceiver connected to said CPU for broadcasting, at a plurality of frequencies, said warning signals carrying data from said CPU; and,
a microphone connected to said transmitter for entraining human speech in said warning signals;
an earth-orbiting satellite for receiving said warning signals and rebroadcasting such so as to extend the range of communications of said base station;
a plurality of receivers for receiving said warning signals from said first, earth-orbiting satellite, each of said receivers being tuned to recognize a respective one of said plurality of radio frequencies; and,
at least one of said receivers having a plurality of colored LEDs each of which being selectively energizeable in response to one of said warning signals so as to convey an impression of the immediate likelihood of an act of terror as proposed by the Office of Homeland Security.
